(19) United States
(12) Patent Application Publication
(10) Pub. No.: US 2006/0154013 A1
(43) Pub. Date: Jul. 13, 2006

(54) Adhesive tape assembly

(76) Inventor: Chia-Lu Wu, Taoyuan (TW)

Correspondence Address: SHOEMAKER AND MATTARE, LTD, 10 POST OFFICE ROAD - SUITE 110, SILVER SPRING, MD, 20910, US

(21) Appl. No.: 11/171,274

(22) Filed: Jul. 1, 2005

(30) Foreign Application Priority Data
Jan. 12, 2005 (TW) 094200595

(51) Int. Cl. B32B 7/12

(52) U.S. Cl. 428/40.1

(57) ABSTRACT

An adhesive tape assembly includes a main body; a plurality of stack-type adhesive tapes arranged in parallel around on a surface of the main body; and at least one elastic member coupled to the main body and arranged over surfaces of the stack-type adhesive tapes, allowing the stack-type adhesive tapes to be secured in place to the main body by the elastic member, such that a large number of the stack-type adhesive tapes can be provided by the single adhesive tape assembly to a user who wishes to use the stack-type adhesive tapes.

### FIELD OF THE INVENTION

The present invention relates to adhesive tape assemblies, and more particularly, to an adhesive tape assembly for providing adhesive tapes to be adhered to articles for identification.

### BACKGROUND OF THE INVENTION

Besides being used to seal containers such as plastic bags, packages, boxes and the like to prevent articles received in the containers from dropping out of the containers, adhesive tapes may also be directly adhered to articles such as desk drawers, cabinets, presswork or equivalents to fix different parts of the articles in place to prevent escapes of the drawers or cabinets during transportation, or for the purpose of identification by the adhesive tapes adhered to the presswork or equivalents.

The adhesive tapes for identification are usually assembled with a dispenser to form an adhesive tape assembly for use in different circumstances. For example, colored adhesive tapes being cut into small pieces are adhered to articles such as boxes for accommodating materials or components in a factory so as to distinguish the articles for a user to identify. Such small pieces of adhesive tapes provided by the dispenser can also be applied for a student to mark textbook pages having key points or to be examined, such that the adhesive tapes are partly adhered to the pages and partly exposed for the student to quickly find the marked pages. Further, such adhesive tapes can also be used to quickly classify documents for identification during a meeting or document arrangement in a general company. Relating prior arts include for example U.S. Pat. Nos. 5,086,946, 5,401,547 and 5,518,144, and Taiwanese Patent No. 461918. A conventional adhesive tape assembly is shown in FIGS. 1 and 2.

As shown in FIG. 1, the conventional adhesive tape assembly 10 comprises a dispenser 102, a stack-type adhesive tape 104, and a bottom plate 106. The dispenser 102 is substantially shaped as a cover for accommodating the stack-type adhesive tape 104, and an opening 1021 is formed substantially at a central portion of the dispenser 102. The stack-type adhesive tape 104 comprises a plurality of stacked piece members 1041, wherein each of the piece members 1041 is partly coated with an adhesive layer and is partly not coated with the adhesive layer. The part coated with the adhesive layer of a piece member 1041 is adjacent to the part not coated with the adhesive layer of a neighboring piece member 1041, such that when an upper piece member 1041 is peeled off, the part coated with the adhesive layer of the upper piece member 1041 associatively lifts up the part not coated with the adhesive layer of a lower piece member 1041. The bottom plate 106 is slightly larger than the dispenser 102 and can be used to secure the dispenser 102 in place.

After the dispenser 102, the stack-type adhesive tape 104 and the bottom plate 106 are assembled together, as shown in FIG. 2, the dispenser 102 is secured to the bottom plate 106, and the part not coated with the adhesive layer of the piece member 1041 (such as the uppermost piece member 1041) of the stack-type adhesive tape 104 is exposed from the opening 1021. Thus, when the adhesive tape assembly 10 is in use and the uppermost piece member 1041 is drawn out from the opening 1021 of the dispenser 102, the part coated with the adhesive layer of the uppermost piece member 1041 being drawn out associatively lifts up the part not coated the adhesive layer of a lower piece member 1041 to be exposed from the opening 1021 such that the lower piece member 1041 is ready for subsequent use.

However, since the adhesive tape assembly operates to allow the piece members of the stack-type adhesive tape to be drawn out from the opening of the dispenser, it can only accommodate a limited thickness of the stack-type adhesive tape. Once all the piece members of the stack-type adhesive tape are used up, the dispenser becomes useless. As a result, a new adhesive tape assembly must be purchased, which not only increased costs for a user but also is not favorable for environmental protection.

Further, as the above adhesive tape assembly can only accommodate the limited thickness of stack-type adhesive tape, such small capacity increases usage costs of the adhesive tape assembly, and requirements such as a large amount of usage, different colors, different widths or others cannot be satisfied, as well as the user should frequently replace a new adhesive tape assembly. This causes usage inconvenience and inflexibility of the above adhesive tape assembly.

Moreover, due to the limitation on thickness of stack-type adhesive tape being accommodated in the adhesive tape assembly and high costs of the dispenser, the price of such adhesive tape assembly is hard to be lowered, the production costs thereof are increased, and the industrial applicability thereof is degraded.

Therefore, it is greatly desirable to provide an adhesive tape assembly, which can solve various problems such as unfavorable for recycling, increase in usage costs, usage inconvenience, usage inflexibility and increase in production costs, which are caused by drawbacks such as small capacity and unfavorable for environmental protection in the conventional technology.

### SUMMARY OF THE INVENTION

In light of the drawbacks in the foregoing conventional technology, an objective of the present invention is to provide an adhesive tape assembly having large capacity.

Another objective of the present invention is to provide an adhesive tape assembly, which is favorable for environmental protection.

Still another objective of the present invention is to provide an adhesive tape assembly, which can reduce usage costs thereof.

A further objective of the present invention is to provide an adhesive tape assembly for providing usage convenience thereof.

A further objective of the present invention is to provide an adhesive tape assembly for providing usage flexibility thereof.

A further objective of the present invention is to provide an adhesive tape assembly, which can improve industrial applicability thereof.

In accordance with the above and other objectives, the present invention proposes an adhesive tape assembly comprising a main body, a plurality of stack-type adhesive tapes, and at least one elastic member.

The main body selectively comprises a hollow structure or a solid pillar. When the main body comprises a hollow structure, the main body is preferably a tube or a rectangular-shaped structure. The stack-type adhesive tapes are arranged in parallel around a surface of the main body, wherein each of the stack-type adhesive tapes comprises a plurality of stacked piece members, and each of the piece members preferably comprises a first portion not coated with an adhesive layer and a second portion coated with the adhesive layer. The elastic member is coupled to the main body and arranged over surfaces of the stack-type adhesive tapes, such that the stack-type adhesive tapes are secured in place to the main body by the elastic member. In an embodiment of the present invention, the elastic member comprises for example a cover structure, which is preferably a transparent cover. In another embodiment, the elastic member can be a ring structure, such as a rubber band or an elastic ring. Further, the elastic member can be formed with an opening.

With the arrangement of a plurality of stack-type adhesive tapes on the main body, a large number of the stack-type adhesive tapes can be provided by the single adhesive tape assembly to a user who wishes to use the stack-type adhesive tapes, and the main body and the elastic member can be repeatedly used, such that the use of a single-time-usage dispenser is omitted, but a function of easy to peel off the piece members of the stack-type adhesive tapes is still retained. This therefore overcomes drawbacks such as not able to satisfy the requirements of a large amount of usage, different colors, different widths or others, and usage inconvenience and inflexibility caused by the need to frequently replace a new adhesive tape assembly as in the conventional technology. Moreover, the adhesive tape assembly in the present invention omits the use of a single-time-usage dispenser and solves problems such as increase in the production costs and difficulty in reducing the price of a conventional adhesive tape assembly.

Therefore, the adhesive tape assembly in the present invention not only has large capacity and is favorable for environmental protection and recycling, but also can reduce usage costs thereof and provide usage convenience and flexibility to thereby enhance industrial applicability thereof, such that various drawbacks in the conventional technology are overcome.

### BRIEF DESCRIPTION OF THE DRAWINGS

The present invention can be more fully understood by reading the following detailed description of the preferred embodiments, with reference made to the accompanying drawings, wherein:

FIG. 1 (PRIOR ART) is an exploded view of a conventional adhesive tape assembly;

FIG. 2 (PRIOR ART) is a perspective view of the adhesive tape assembly of FIG. 1 after being assembled;

FIG. 3 is an exploded view of an adhesive tape assembly in accordance with a first preferred embodiment of the present invention;

FIG. 4A is a perspective view of the adhesive tape assembly of FIG. 3 after being assembled;

FIG. 4B is a schematic diagram showing the adhesive tape assembly of the first preferred embodiment in use;

FIG. 5 is an exploded view of the adhesive tape assembly in accordance with a second preferred embodiment of the present invention;

FIG. 6A is a schematic diagram showing the adhesive tape assembly of the second preferred embodiment in use;

FIG. 6B is another schematic diagram showing the adhesive tape assembly of the second preferred embodiment in use; and

FIG. 7 is a schematic diagram of the adhesive tape assembly in accordance with a third preferred embodiment of the present invention.

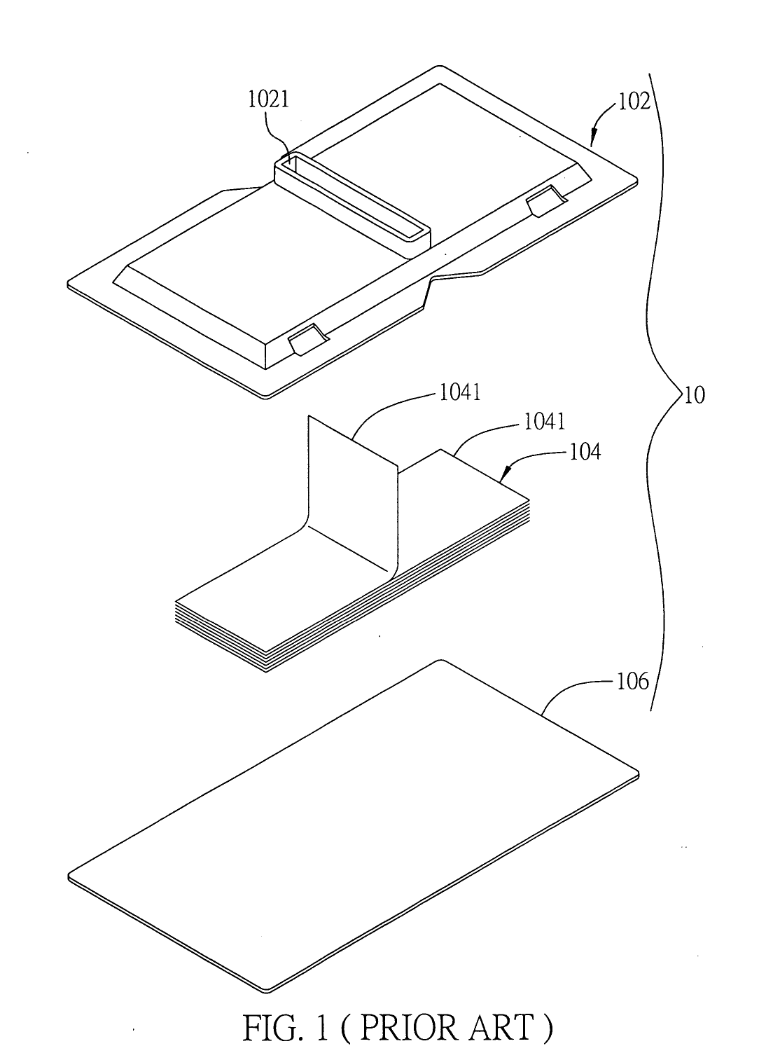

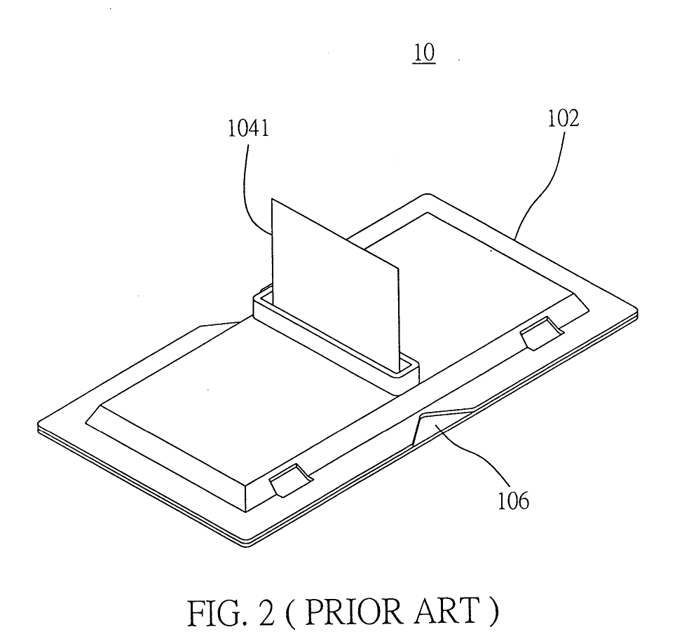

### DETAILED DESCRIPTION OF THE PREFERRED EMBODIMENTS

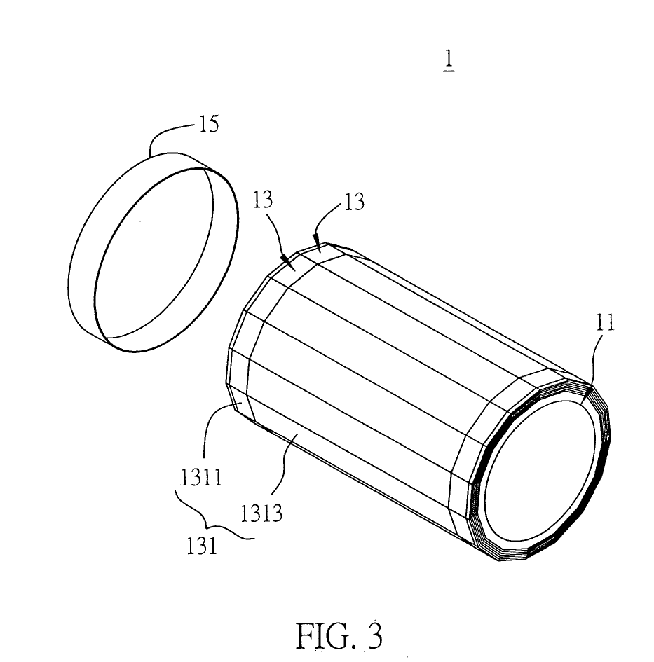

Preferred embodiments of an adhesive tape assembly proposed in the present invention are described in detail with reference to FIGS. 3 to 7, which are not for limiting the scope of the present invention.

### First Preferred Embodiment

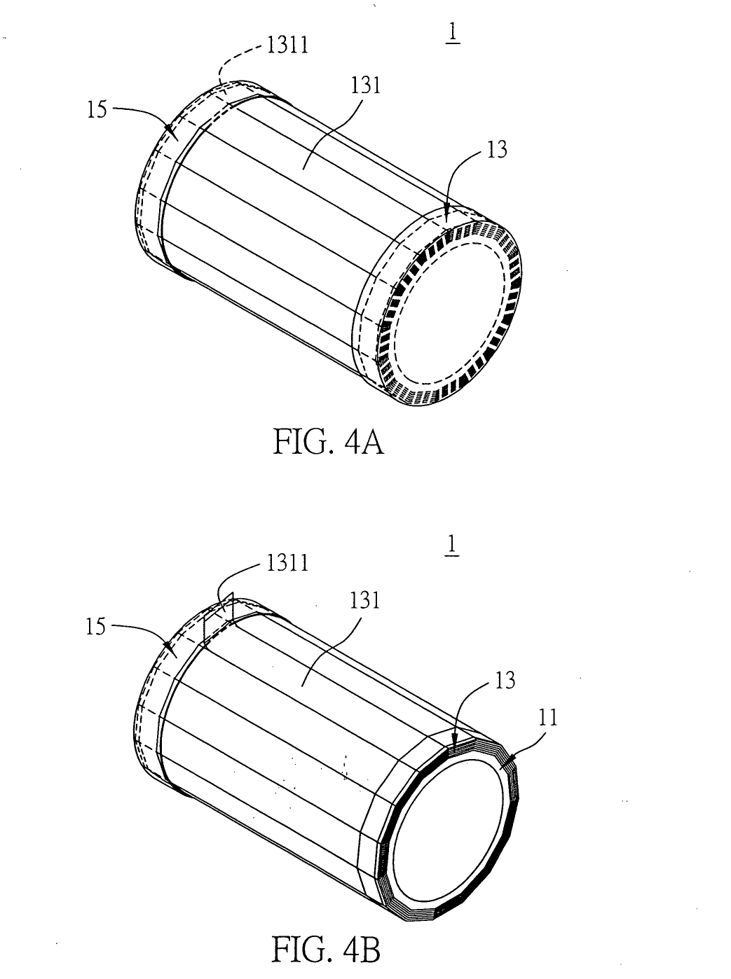

FIGS. 3, 4A and 4B are schematic diagrams of the adhesive tape assembly in accordance with a first preferred embodiment of the present invention. As shown in the drawings, the adhesive tape assembly 1 of this embodiment comprises a main body 11, a plurality of stack-type adhesive tapes 13, and an elastic member 15. It should be noted that the drawings are simplified schematic diagrams used to only show the basic structure of the present invention and components associated with the present invention, wherein the components are not drawn in real shape and size, and the number, shape and size of the components are flexibly arranged according to the design, making the structure of the adhesive tape assembly more complicated in practical implementation.

As shown in FIG. 3, the main body 11 comprises a hollow structure such as a tube or any other equivalent structure. The plurality of stack-type adhesive tapes 13 are arranged in parallel around a surface of the main body 11, and each of the stack-type adhesive tapes 13 comprises a plurality of stacked piece members 131. Each of the piece members 131 comprises a first portion 1311 not coated with an adhesive layer and a second portion 1313 coated with the adhesive layer. In this embodiment, each of the stack-type adhesive tapes 13 has the same stacked structure as a conventional stack-type adhesive tape, which is not to be detailed herein. The elastic member 15 comprises a circular cover structure corresponding to the shape of the main body 11, wherein the elastic member 15 can be, but not limited to, a transparent cover. When the elastic member 15 is a transparent cover, it allows a user to easily select and peel off any of the stack-type adhesive tapes 13 of different colors.

As shown FIG. 4, the elastic member 15 is disposed at an end of the main body 11 and is arranged over a portion of surfaces of the stack-type adhesive tapes 13 for example at the periphery of the stack-type adhesive tapes 13 such that the stack-type adhesive tapes 13 are secured in place to the main body 11 by the elastic member 15. The user can for example lift up the first portion 1311 not coated with the adhesive layer of a piece member 131 (such as the uppermost piece member 131) of one of the stack-type adhesive tapes 13 to peel off the uppermost piece member 131. Since the elastic member 15 secures the portion of surfaces of the stack-type adhesive tapes 13 in place, as shown in FIG. 4B, by the user's action of peeling off the uppermost piece member 131, the adhesive tape assembly 1 may associatively lift up the first portion 1311 not coated with the adhesive layer of a lower piece member 131 originally located under the uppermost piece member 131 so as to expose the first portion 1311 of the lower piece member 131 from the elastic member 15, such that the user can subsequently peel off the lower piece member 131. When all of the stack-type adhesive tapes 13 are used up, the main body 11 and the elastic member 15 can be recycled in a manner to place new stack-type adhesive tapes 13 on the main body 11 and couple the elastic member 15 to the main body 11 having the new stack-type adhesive tapes 13, such that the adhesive tape assembly 1 is ready for use again.

In this embodiment, each of the piece members 131 of the stack-type adhesive tapes 13 comprises the first portion 1311 not coated with the adhesive layer and the second portion 1313 coated with the adhesive layer, wherein the first and second portions 1311, 1313 may have different colors for the purpose of identification when being adhered to articles, however, it should be noted that the position and area coated with the adhesive layer can be flexibly modified and are not limited to the arrangement in this embodiment. Moreover, in this embodiment, the piece members 131 of the stack-type adhesive tapes 13 may in advance be subjected to roughening or other equivalent treatments to allow writing to be performed on surfaces of the piece members 131 or provide other functions to the surfaces of the piece members 131. The roughening or other equivalent treatments on the surfaces of the piece members 131 are well known in the art and thus not to be further detailed herein.

As the stack-type adhesive tapes 13 are arranged around the surface of the main body 11, the adhesive tape assembly in the present invention can accommodate a plurality of the stack-type adhesive tapes 13 and has an advantage of large capacity over the conventional technology, and the main body 11 and the elastic member 15 both can be recycled and reused, thereby favorable for environmental protection.

Further, the adhesive tape assembly in the present invention having large capacity can reduce usage costs thereof, such that the user needs not frequently replace a new adhesive tape assembly, and the stacked adhesive layers 13 may selectively have different colors or shapes, thereby providing identifying and coloring effects when being adhered to articles. Moreover, the hollow main body 11 may be sleeved around a corresponding fixed member (not shown), such that the main body 11 can be freely rotated by the user to select the stack-type adhesive tape 13 having a desirable color or shape. Therefore, the adhesive tape assembly in the present invention can provide usage convenience and flexibility, and further enhance the industrial applicability thereof, thereby overcoming various drawbacks in the conventional technology.

### Second Preferred Embodiment

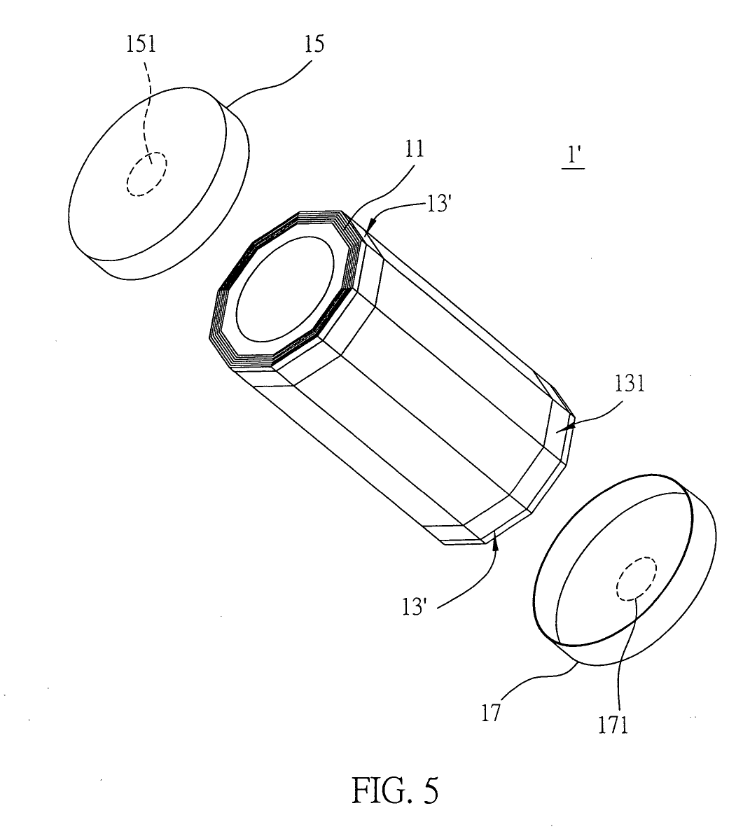

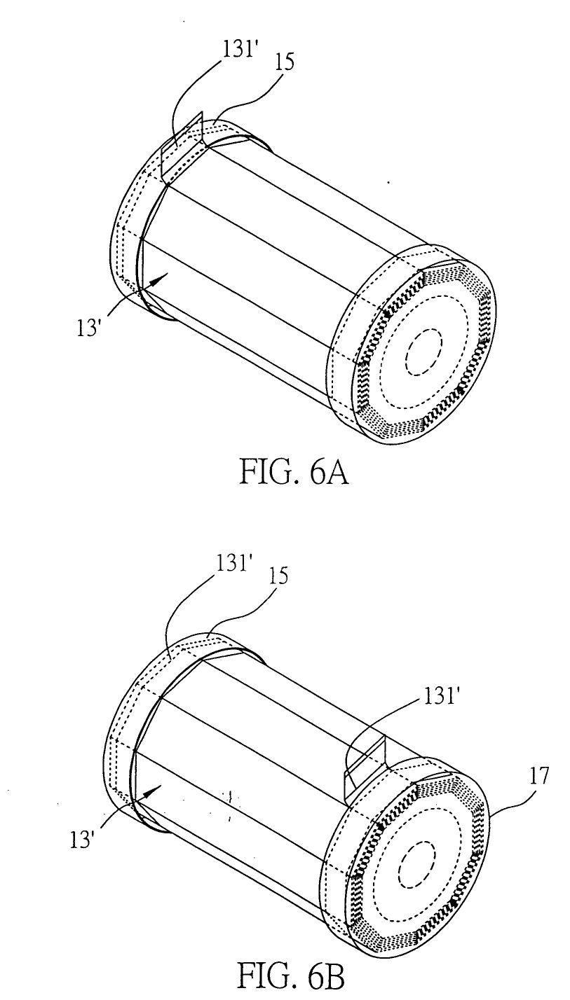

FIGS. 5, 6A and 6B are schematic diagrams of the adhesive tape assembly in accordance with a second preferred embodiment of the present invention. As shown in the drawings, the adhesive tape assembly 1′ of the second embodiment comprises a main body 11, a plurality of stack-type adhesive tapes 13, and two elastic members 15, 17, wherein same or similar elements as or to those in the first embodiment are designated with same or similar reference numerals and detailed descriptions thereof are omitted for the sake of clarify, and wherein this embodiment has the same functions as the above first embodiment and the same description thereof is not repeated here, such that only the difference of this embodiment from the first embodiment is described herein to make the present invention easier to be understood.

As shown in FIG. 5, the adhesive tape assembly 1′ of this embodiment differs the adhesive tape assembly 1 of the first embodiment in that, the adhesive tape assembly 1′ is provided with the plurality of stack-type adhesive tapes 13′ having different widths, and the two elastic members 15, 17 oppositely disposed at two ends of the main body 11.

As shown in FIG. 6A, a portion not coated with the adhesive layer of a piece member 131′ (such as the uppermost piece member 131′) of one of the stack-type adhesive tapes 13′ can be lifted up via the elastic member 15 at one end of the main body 11 by the user to peel off the uppermost piece member 131′. As shown in FIG. 6B, by the peeling off of the uppermost piece member 131′, a portion not coated with the adhesive layer of a lower piece member 131′ originally located under the uppermost piece member 131′ can be associatively lifted up and exposed from the elastic member 17 at the other end of the main body 11.

In this embodiment, the two elastic members 15, 17 can ensure the piece members 131′ of the stack-type adhesive tapes 13′ to be lifted up from the two ends of the main body 11. Further as shown in FIG. 5, openings 151, 171 (as shown by dotted lines) can be respectively formed in the elastic members 15, 17, such that the main body 11 can be hung to an appropriate position by means of an article such as a hanger (not shown) extending through the openings 151, 171, making the user conveniently peel off the piece members 131′ of the stack-type adhesive tapes 13′ of the adhesive tape assembly 1′ that does not occupy significant space.

### Third Preferred Embodiment

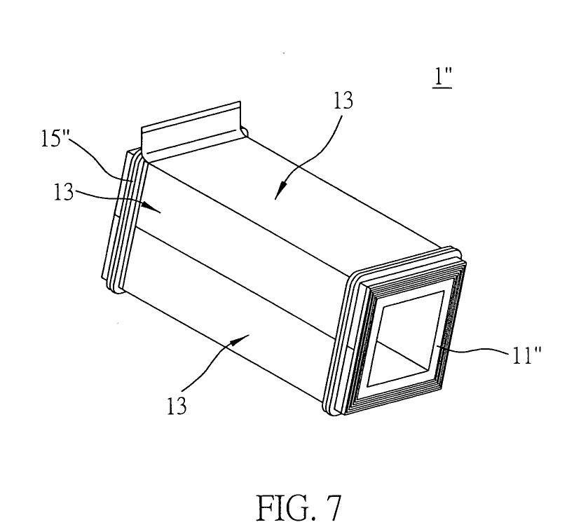

FIG. 7 is a schematic diagram of the adhesive tape assembly in accordance with a third preferred embodiment of the present invention. As shown in FIG. 7, the adhesive tape assembly 1″ of the third embodiment comprises a main body 11″, a plurality of stack-type adhesive tapes 13, and an elastic member 15″, wherein same or similar elements as or to those in the first embodiment are designated with same or similar reference numerals and detailed descriptions thereof are omitted for the sake of clarify, and description of the same functions is not repeated herein.

As shown in FIG. 7, the adhesive tape assembly 1″ differs from those in the above embodiments in that, the adhesive tape assembly 1″ uses a rectangular-shaped main body 11″ in place of the main body 11 shaped as a tube structure of the above embodiments, and also uses a ring structure such as a rubber band or any other elastic ring as the elastic member 15″ disposed at one end of the main body 11″.

Therefore, when the adhesive tape assembly in the present invention is applied, the structure of the main body can be modified according to different requirements, as long as a plurality of the stack-type adhesive tapes can be arranged on the surface of the main body. The color, width or shape of each of the stack-type adhesive tapes is not limited to those described in the above embodiments. The structure of the elastic member can also be flexibly designed and modified according to different requirements. Moreover, it is also feasible to in advance form a strip of stack-type adhesive tapes, and then to divide the strip into individual stack-type adhesive tapes having different colors or shapes according to the design so as to shorten the fabrication time.

Therefore, the present invention can solve various problems such as unfavorable for recycling, increase in usage costs, usage inconvenience, usage inflexibility and increase in production costs, which are caused by drawbacks of small capacity and unfavorable for environmental protection as in the conventional technology. The present invention provides an adhesive tape assembly having large capacity, which is favorable for environmental protection and recycling, reduces usage costs, and provides usage convenience and flexibility, thereby enhancing the industrial applicability thereof.

The present invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. An adhesive tape assembly, comprising:
a main body;
a plurality of stack-type adhesive tapes arranged in parallel around a surface of the main body; and
at least one elastic member coupled to the main body and arranged over surfaces of the stack-type adhesive tapes, allowing the stack-type adhesive tapes to be secured in place to the main body by the elastic member.

2. The adhesive tape assembly as claimed in claim 1, wherein the main body comprises a hollow structure.

3. The adhesive tape assembly as claimed in claim 2, wherein the main body comprises a tube or a rectangular-shaped structure.

4. The adhesive tape assembly as claimed in claim 1, wherein the main body comprises a solid pillar.

5. The adhesive tape assembly as claimed in claim 1, wherein each of the stack-type adhesive tapes comprises a plurality of stacked piece members.

6. The adhesive tape assembly as claimed in claim 5, wherein each of the piece members comprises a first portion free of being coated with an adhesive layer, and a second portion coated with the adhesive layer.

7. The adhesive tape assembly as claimed in claim 1, wherein the elastic member comprises a cover structure.

8. The adhesive tape assembly as claimed in claim 7, wherein the elastic member is a transparent cover.

9. The adhesive tape assembly as claimed in claim 1, wherein the elastic member comprises a ring structure.

10. The adhesive tape assembly as claimed in claim 9, wherein the elastic member is a rubber band or an elastic ring.

11. The adhesive tape assembly as claimed in claim 1, wherein the elastic member is formed with an opening.
